(19) United States
(12) Patent Application Publication
(10) Pub. No.: US 2010/0170306 A1
(43) Pub. Date: Jul. 8, 2010

(54) ZIPPER PASSWORD LOCK

(76) Inventors: Chun Lai FONG, Hong Kong (HK); Hau Man Yiu, Hong Kong (HK)

Correspondence Address: BYIP, LTD., P.O. BOX 1484, GENERAL POST OFFICE, HONG KONG, HK

(21) Appl. No.: 12/651,481

(22) Filed: Jan. 4, 2010

(30) Foreign Application Priority Data
Jan. 6, 2009 (HK) 09100103.5

(51) Int. Cl. E05B 65/52; E05B 37/02

(52) U.S. Cl. 70/57; 70/317; 70/332; 70/68

(57) ABSTRACT

A zipper password lock includes a lock tongue and a lock body assembly. The lock tongue includes a first engaging member disposed at a side of the lock tongue. The lock body assembly includes a housing having a lock groove for the lock tongue to be inserted into and a mounting base for securing the housing, and a dial wheel connected to a side of the housing, the dial wheel including a first side with a plurality of marks visible to a user and a second side including a password portion corresponding to one of the marks and a plurality of locking portions respectively corresponding to the other marks. When the lock tongue is inserted into the lock groove, the dial wheel is configured to be rotated by the user to a first position where one of the locking portions is engaged with the first engaging member so that the zipper password lock is set to a locked mode, and to a second position where the password portion is aligned with the first engaging member and none of the locking portions is engaged with the first engaging member so that the zipper password lock is set to an unlocked mode.

### CROSS-REFERENCE TO RELATED APPLICATIONS

This application claims the benefit of Hong Kong Patent Application No. 09100103.5, filed on Jan. 6, 2009; the contents of which is hereby incorporated by reference.

### FIELD OF THE PATENT APPLICATION

The present invention generally relates to a password lock and more particularly to a zipper password lock that is secure and convenient to use.

### BACKGROUND

Many people have experiences of having personal belongings in their handbags or backpacks stolen. To prevent their belongings from being stolen from their backpacks, some people have to keep the backpacks in front of their eyes all the time, which may cause a lot of inconveniences. One of the main reasons that a backpack may be easy to steal from is that the zipper thereof may be easily opened by a thief.

Conventional padlocks and password locks have been used to prevent zippers from being easily opened. A padlock or a password lock external to the zipper may lock two sliders of a two-way zipper together so that the sliders can only move together and not be easily separated.

Some password locks are configured and disposed directly on a luggage case. With such a password lock, two sliders of a zipper of the luggage case may be moved to specific positions on the password lock so as to be locked and fixed to those specific positions.

### SUMMARY

The present patent application is directed to a zipper password lock for locking a zipper. The zipper password lock includes a lock tongue and a lock body assembly. The lock tongue includes a first engaging member disposed at a side of the lock tongue. The lock body assembly includes a housing having a lock groove for the lock tongue to be inserted into and a mounting base for securing the housing; and a dial wheel connected to a side of the housing. The dial wheel includes a first side with a plurality of marks visible to a user, and a second side including a password portion corresponding to one of the marks and a plurality of locking portions respectively corresponding to the other marks. When the lock tongue is inserted into the lock groove, the dial wheel is configured to be rotated by the user to a first position where one of the locking portions is engaged with the first engaging member so that the zipper password lock is set to a locked mode, and to a second position where the password portion is aligned with the first engaging member and none of the locking portions is engaged with the first engaging member so that the zipper password lock is set to an unlocked mode.

The lock tongue may further include a third engaging member disposed at another side thereof, and the lock body assembly may further include another dial wheel connected to another side of the housing. The dial wheel includes a first side with a plurality of marks visible to a user, and a second side including a password portion corresponding to one of the marks and a plurality of locking portions respectively corresponding to the other marks.

The zipper password lock may further include a second engaging member disposed in the housing and axially movable between the dial wheel and the lock tongue. The first engaging member may be a concave lock catch, the second engaging member may be a protruding lock plug, and when the dial wheel is rotated to the first location, one of the locking portions may be indirectly engaged with the first engaging member by pushing the second engaging member to be directly engaged with the first engaging member.

At least one of the upper side and the lower side of the lock tongue may include a concave portion, a spring clip may be disposed on the mounting base of the housing, and at least an end of the spring clip may be configured to engage with the concave portion when the lock tongue is inserted into the lock groove.

In another aspect, the present patent application provides a zipper password lock for locking a two-way zipper. The zipper includes a first slider and a second slider. The zipper password lock includes a lock tongue fixed to the first slider and a lock body assembly fixed to the second slider. The lock tongue includes a first engaging member disposed at a side of the lock tongue. The lock body assembly includes a housing having a lock groove for the lock tongue to be inserted into and a mounting base for securing the housing; and a dial wheel connected to a side of the housing. The dial wheel includes a first side with a plurality of marks visible to a user, and a second side including a password portion corresponding to one of the marks and a plurality of locking portions respectively corresponding to the other marks. When the lock tongue is inserted into the lock groove, the dial wheel is configured to be rotated by the user to a first position where one of the locking portions is engaged with the first engaging member so that the zipper password lock is set to a locked mode, and to a second position where the password portion is aligned with the first engaging member and none of the locking portions is engaged with the first engaging member so that the zipper password lock is set to an unlocked mode.

In yet another embodiment, the present patent application provides a zipper password lock for locking a one-way zipper. The zipper includes a slider and a fixed member. The zipper password lock includes a lock tongue fixed to one of the slider and the fixed member and a lock body assembly fixed to the other of the slider and the fixed member. The lock tongue includes a first engaging member disposed at a side of the lock tongue. The lock body assembly includes a housing having a lock groove for the lock tongue to be inserted into and a mounting base for securing the housing; and a dial wheel connected to a side of the housing. The dial wheel includes a first side with a plurality of marks visible to a user, and a second side including a password portion corresponding to one of the marks and a plurality of locking portions respectively corresponding to the other marks. When the lock tongue is inserted into the lock groove, the dial wheel is configured to be rotated by the user to a first position where one of the locking portions is engaged with the first engaging member so that the zipper password lock is set to a locked mode, and to a second position where the password portion is aligned with the first engaging member and none of the locking portions is engaged with the first engaging member so that the zipper password lock is set to an unlocked mode.

### BRIEF DESCRIPTION OF THE DRAWINGS

FIG. 1 is a perspective view of a zipper password lock according to an embodiment of the present patent application.

FIG. 2 is an exploded view of the zipper password lock depicted in FIG. 1.

FIG. 3 is another exploded view of the zipper password lock depicted in FIG. 1.

FIG. 4 is a partial perspective view of the zipper password lock depicted in FIG. 1 when a C-shaped spring clip and a concave portion of the lock tongue are engaged.

FIG. 5 is a partial perspective view of the zipper password lock depicted in FIG. 1 illustrating the spatial relationship between a spring positioning member and a dial wheel.

FIG. 6 is a cross-sectional view of the zipper password lock depicted in FIG. 1 in a locked mode.

FIG. 7 is a cross-sectional view of the zipper password lock depicted in FIG. 1 in an unlocked mode when the lock tongue is not yet withdrawn.

FIG. 8 is a perspective view of a zipper password lock according to another embodiment of the present patent application.

FIG. 9 is a perspective view of a zipper password lock according to yet another embodiment of the present patent application.

FIG. 10 is an exploded perspective view of a zipper password lock according to still another embodiment of the present patent application.

FIG. 11 is a cross-sectional view of the zipper password lock depicted in FIG. 10 in a locked mode.

FIG. 12 is a cross-sectional view of the zipper password lock depicted in FIG. 10 in an unlocked mode when the lock tongue is not yet withdrawn.

### DETAILED DESCRIPTION

Reference will now be made in detail to a preferred embodiment of the zipper password lock disclosed in the present patent application, examples of which are also provided in the following description. Exemplary embodiments of the zipper password lock disclosed in the present patent application are described in detail, although it will be apparent to those skilled in the relevant art that some features that are not particularly important to an understanding of the zipper password lock may not be shown for the sake of clarity.

Furthermore, it should be understood that the zipper password lock disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

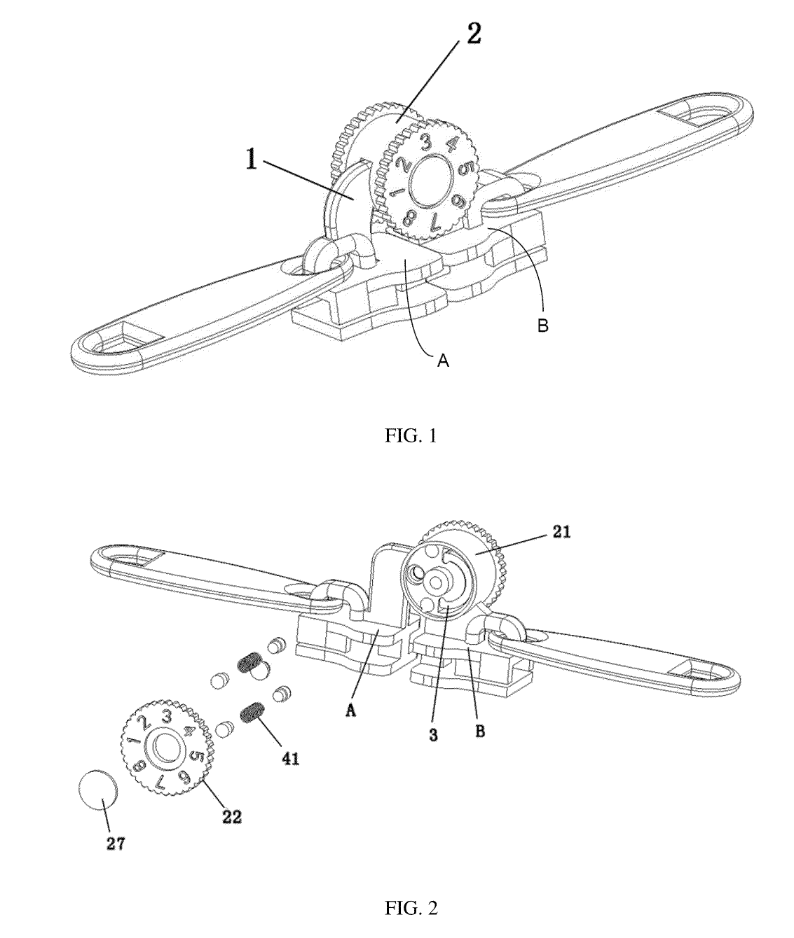

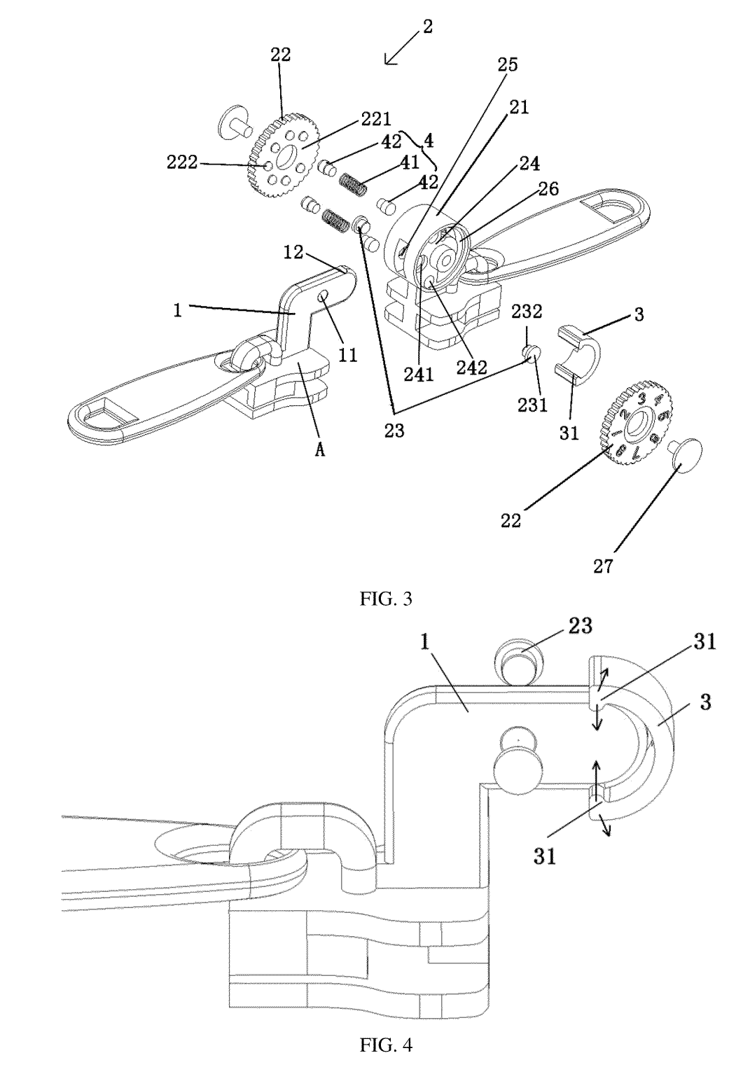

FIG. 1 is a perspective view of a zipper password lock according to an embodiment of the present patent application. FIG. 2 is an exploded view of the zipper password lock depicted in FIG. 1. FIG. 3 is another exploded view of the zipper password lock depicted in FIG. 1. Referring to FIGS. 1-3, the zipper password lock includes a lock tongue 1 and a lock body assembly 2, either one of which is fixedly mounted to a slider of a two-way zipper while the other is fixedly mounted to another slider of the zipper. For example, referring to FIG. 1 and FIG. 2, the lock tongue 1 is fixed on a slider A, forming an integral structure with the slider A. The lock body assembly 2 is fixed on a slider B, forming an integral structure with the slider B.

Referring to FIG. 3, at least a side of the lock tongue 1 includes a concave lock catch 11. In this embodiment, two sides of the lock tongue 1 each includes a concave lock catch 11 disposed in a middle portion thereof. The lock body assembly 2 includes a housing 21, at least a rotatable dial wheel 22 and at least a lock plug 23. In this embodiment, the lock body assembly 2 includes a cylindrical housing 21, two rotatable dial wheels 22 and two lock plugs 23.

A mounting base 24 is fixedly disposed in the housing 21. A lock groove 25 is configured on the housing 21 and configured for the lock tongue 1 to be inserted into. The lock groove 25 extends through the outside wall of the housing 21 radially to the inside of the mounting base 24.

The two dial wheels 22 are respectively connected to the two sides of the housing 21 through two combining members 27. A first side of each dial wheel 22 has a plurality of marks printed thereon. In this embodiment, the marks are numbers “1”, “2”, . . . , “8”, and arranged to be separated from one another by a constant distance. The first sides of the dial wheels 22 are exposed to the outside of the housing 21 and visible to a user. A second side of each dial wheel 22 is facing the inside of the housing 21. The second side of the dial wheel 22 includes a password portion 221 and a plurality of locking portions 222. In this embodiment, there are seven locking portions 222 for each dial wheel 22. The password portion 221 corresponds to one of the marks on the first side of the dial wheel 22. The other marks on the first side of the dial wheel 22 respectively correspond to the plurality of the locking portions 222. In this embodiment, each locking portion 222 has a semi-sphere shape and protrudes from the second side of the dial wheel 22. The password portion 221 is essentially a flat surface that is not protruding from the second side of the dial wheel 22. The password portions 221 of the two dial wheels 22 may correspond to the same or different marks. For example, in FIG. 3, the password portion 221 of the dial wheel 22 on the left may correspond to the mark “3” while the password portion 221 of the dial wheel 22 on the right corresponds to the mark “8”. Each of the two lock plugs 23 is disposed between each dial wheel 22 and the lock tongue 1, and axially movable in the housing 21.

When the lock tongue 1 is inserted into the lock groove 25, each dial wheel 22 may be rotated so as to drive the lock plug 23 to engage or disengage with the concave lock catch 11. More specifically, when the dial wheel 22 is rotated by a user, the locking portions 222 of the second side of the dial wheel 22 may push the lock plug 23 to move axially to be inserted into the concave lock catch 11 so that the lock tongue 1 can not be withdrawn from the lock groove 25 and the zipper password lock is in a locked mode. If the dial wheel 22 is further rotated until the password portion 221 on the second side of the dial wheel 22 faces the lock plug 23, the lock plug 23 is no longer pushed and thus become disengaged from the concave lock catch 11. As a result, the lock tongue 1 can be withdrawn from the lock groove 25 by a slight pull and the zipper password lock is unlocked.

In this embodiment, a through hole 241 is configured on a location on the mounting base 24 that corresponds to the location of each lock plug 23. The lock plug 23 includes a main unit 231 and an extension 232, which are fixedly and coaxially connected with each other. The diameter of the main unit 231 is greater than the diameter of the through hole 241. The diameter of the extension 232 is less than the diameter of the through hole 241. As a result, the extension 232 can go through the through hole 241 and be stopped by the main unit 231. To further ensure that the lock tongue 1 can be withdrawn from the lock groove 25, the end of the extension 232 opposing the main unit 231 preferably has a curved shape or a chamber end shape. Alternatively, a spring (not shown in FIG. 3) may be configured to cover the extension 232, with one end pushing the main unit 231 and the other end pushing the mounting base 24. With this configuration, when the main unit 231 is not pushed by the locking portions 222, the spring can push back the lock plug 23.

In this embodiment, the main unit 231 and the locking portions 222 are configured in a way that only when aligned with the password portion 221 of the dial wheel 22, the main unit 231 loses the push force so that lock plug 23 moves back and the zipper password lock is unlocked; when aligned with the locking portions 222 or the positions between the locking portions 222, the main unit 231 is pushed so that the lock plug can not move back and the zipper password lock is locked.

FIG. 4 is a partial perspective view of the zipper password lock depicted in FIG. 1 when a C-shaped spring clip and a concave portion of the lock tongue are engaged. Referring to FIG. 4, at least one of the upper side and the lower side of the lock tongue 1 includes a concave portion 12. In this embodiment, the upper side and the lower side of the lock tongue respectively have a concave portion 12. A spring clip 3 is disposed on the mounting base 24 of the housing 21. The spring clip 3 faces the lock groove 25. When the lock tongue 1 is inserted into the lock groove 25, at least an end (in this embodiment both ends) of the spring clip 3 are clipped into the concave portion 12 so as to fix the lock tongue 1. The spring clip 3 may be a C-shaped spring clip. The two ends of the C-shaped spring clip 3 respectively have a clipping portion 31. More specifically, referring to FIG. 3 and FIG. 4, a hollow space 26 corresponding to the shape of the C-shaped spring clip 3 is axially defined in an end of the mounting base 24 facing away from the lock groove 25. The lock groove 25 is radially configured and connected through with the hollow space 26. The C-shaped spring clip 3 may be engaged in the hollow space 26 while the clipping portion 31 is accommodated by the lock groove 25. When the lock tongue 1 is inserted into the lock groove 25, the two ends of the C-shaped spring clip 3 are engaged with the concave portion 12 so as to fix the lock tongue 1. Because of the good elasticity of the C-shaped spring clip, at this point only a slight force is sufficient to withdraw the lock tongue 1 from the lock groove 25. With such structure, a user may sense that the lock tongue 1 is in a ready position by clipping of the spring clip 3 and continue with the following locking action.

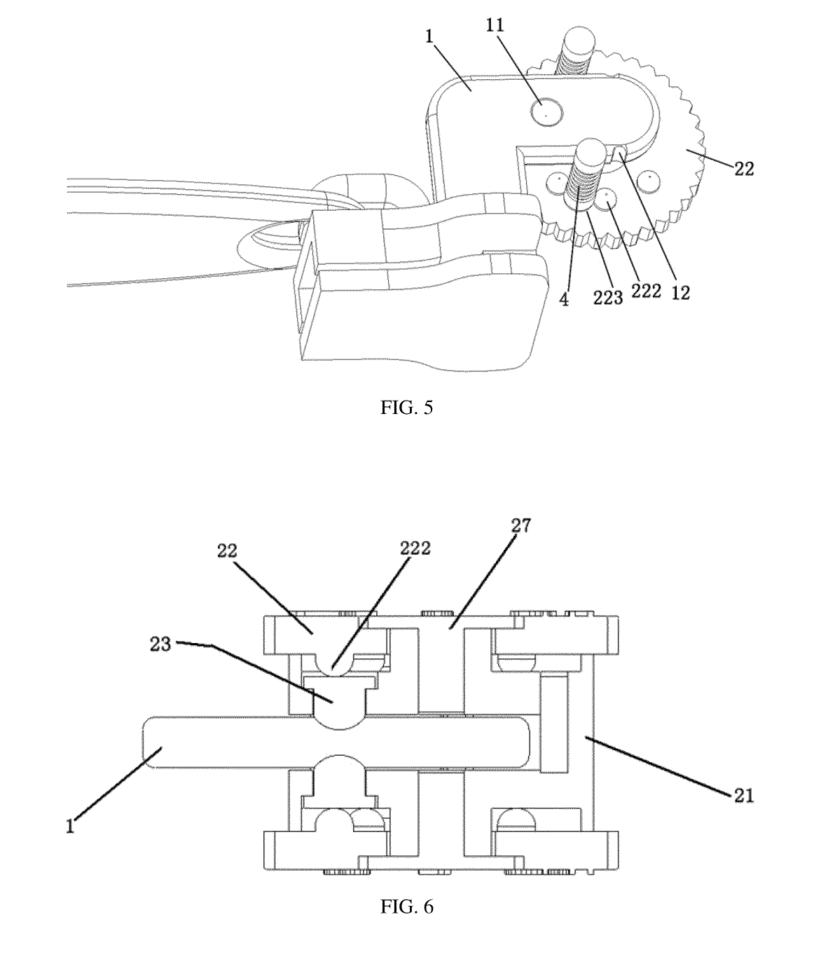

FIG. 5 is a partial perspective view of the zipper password lock depicted in FIG. 1 illustrating the spatial relationship between a spring positioning member and a dial wheel. Referring to FIG. 3 and FIG. 5, at least a spring positioning member 4 is axially disposed in the housing 21. In this embodiment, there are two spring positioning members 4 respectively disposed on the upper and lower sides of the lock groove 25. The spring positioning members 4 are radially fixed with two ends contacting and pushing the two dial wheels 22. The ends of the spring positioning members 4 are disposed at a location 223 between two locking portions 222 on each dial wheel 2 slightly towards the outer edge of the dial wheel 22. The spring positioning members 4 are in contact with the locking portions 222. More specifically, two through holes 242 are axially configured on the mounting base 24 for accommodating the spring positioning members 4. The two ends of the spring positioning members 4 extend out of the through holes 242. Further, each spring positioning member 4 includes a spring 41 and two positioning plugs 42. The two positioning plugs 42 are respectively disposed at the two ends of the spring 41. The two positioning plugs 42 respectively contact and push the two dial wheels 22. Because the spring positioning member 4 is disposed between the two dial wheels 22, the friction between the dial wheel 22 and the housing 21 is avoided so that it is easier to rotate the dial wheels 22, and the dial wheel 22 is prevented from rotating by itself when no force is exerted thereon by a user. In addition, when the dial wheel 22 is being rotated, with the contact between the locking portions 222 and the positioning plug 42, a slight clicking sound is generated, which makes the user clear about the working status of the dial wheel 22, or enables the user to sense which position on the dial wheel 22 corresponds to the lock plug 23.

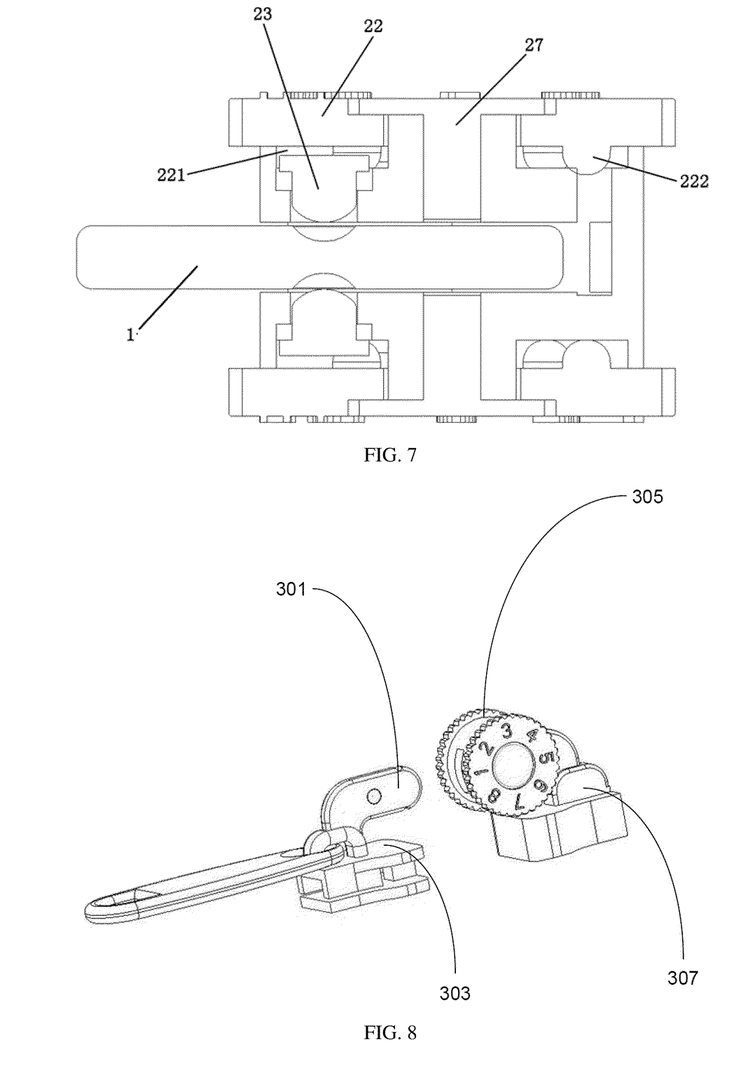

In this embodiment, in operation, the slider A or the slider B may be pulled by a user to move so that the lock tongue 1 is inserted into the lock groove 25 of the lock body assembly 2. The two ends of the C-shaped spring clip 3 are respectively engaged with the concave portions 12 of the lock tongue 1. Through the clipping of the C-shaped spring clip 3, the user may sense the lock tongue 1 is in a ready position. The user may then rotate the two dial wheels 22 respectively so that the locking portions 222 thereon are roughly aligned with the lock plugs 23. The locking portions 222 push the extension 232 of the lock plug 23 through the through hole 241 to be put into the concave lock catch 11 so that the lock tongue 1 and the lock body assembly 2 are fixedly combined and the zipper password lock is in a locked mode for preventing the handbag or backpack having the zipper password lock from being accessed by a thief, as illustrated in FIG. 6, which is a cross-sectional view of the zipper password lock depicted in FIG. 1 in a locked mode. When the user need to unlock the zipper password lock, he may then rotate the two dial wheels 22 respectively so that the password portions 221 on the dial wheels 22 are aligned with the lock plugs 23. Since the lock plugs 23 have lost the push force from the locking portions 222, the user only need to apply a slight force to withdraw the lock tongue 1 from the lock body assembly 2 so as to unlock the zipper password lock, as illustrated in FIG. 7, which is a cross-sectional view of the zipper password lock depicted in FIG. 1 in an unlocked mode when the lock tongue is not yet withdrawn.

In another embodiment of the present patent application, there is only one dial wheel 22, which is connected to one side of the housing 21. The other side of the housing 21 is sealed. The spring positioning member includes only one spring 41 and one positioning plug 42 disposed at an end of the spring 41 and contacting the second side of the dial wheel 22. The other end of the spring 41 without the positioning plug 42 is in contact with the sealed side of the housing 21. In this embodiment, only one concave lock catch 11 is disposed on the lock tongue 1 and one lock plug 23 is disposed between the lock tongue 1 and the dial wheel 22. It is understood that in the zipper password lock, only one password is needed to unlock the lock.

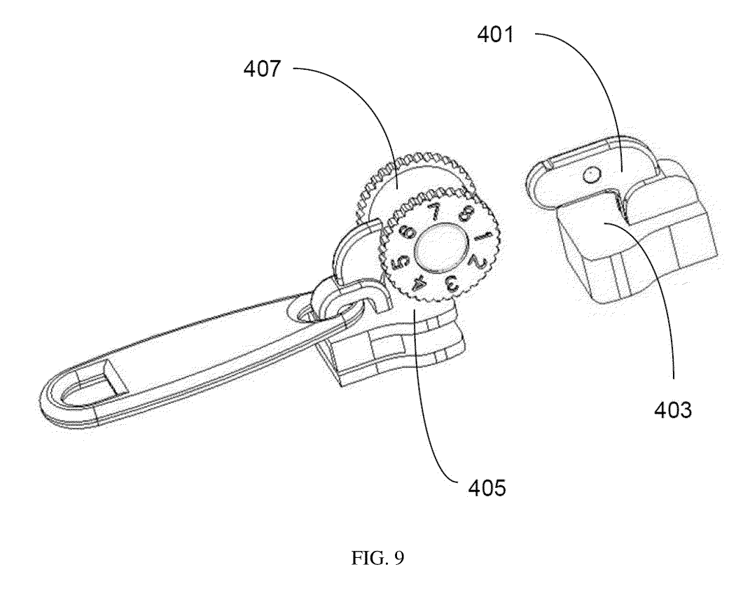

The zipper password lock in the aforementioned embodiments may also be used in one-way zippers of handbags, backpacks or luggage bags. As illustrated in FIG. 8, the lock tongue 301 may be fixedly mounted to the slider 303 of the one-way zipper while the lock body assembly 305 is fixedly mounted to a fixed member 307 of the one-way zipper. Alternatively, as illustrated in FIG. 9, the lock body assembly 407 may be fixedly mounted to the slider 405 of the one-way zipper while the lock tongue 401 is fixedly mounted to a fixed member 403 of the one-way zipper. In both of the embodiments illustrated in FIG. 8 and FIG. 9, when the zipper is closed, the lock tongue is inserted into the lock body assembly.

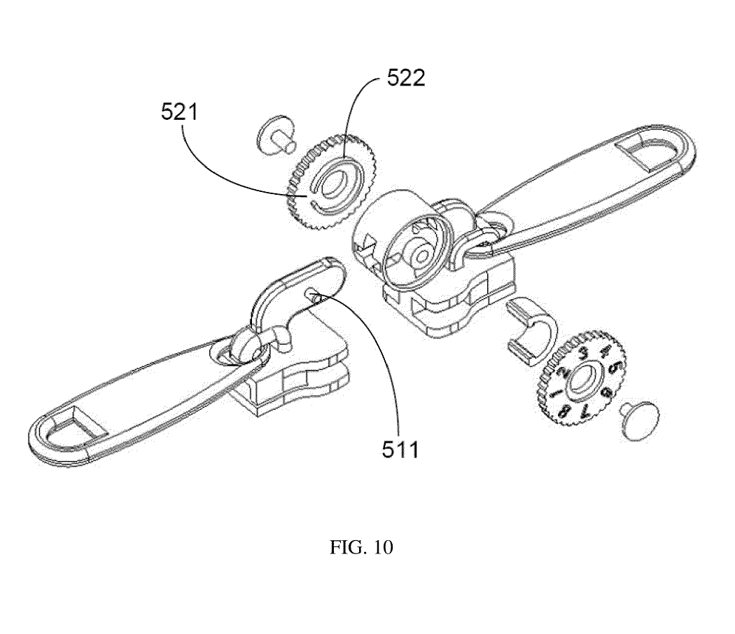

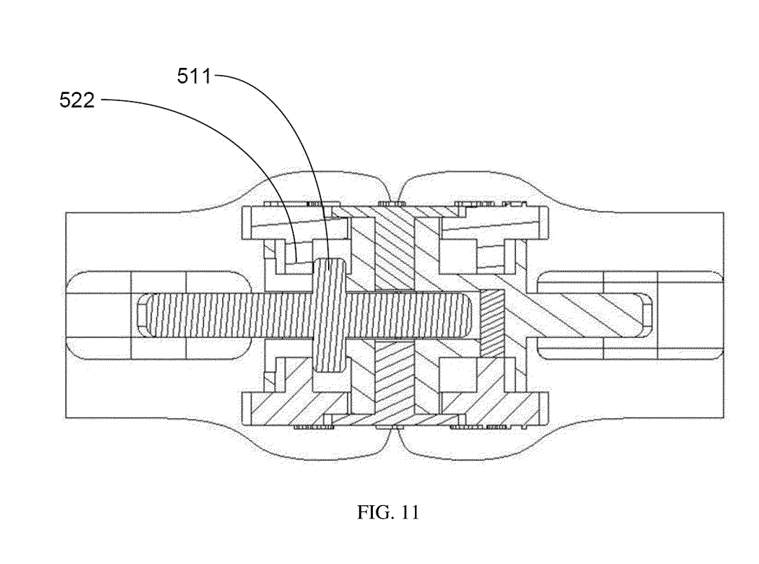

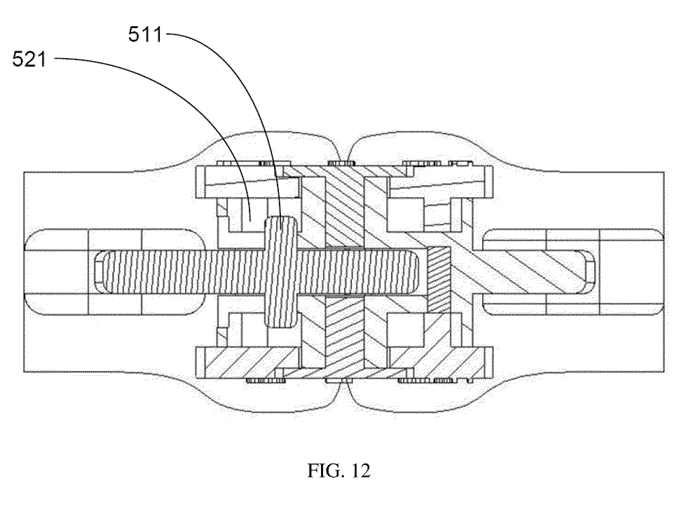

FIG. 10 is an exploded perspective view of a zipper password lock according to still another embodiment of the present patent application. Comparing to the embodiment illustrated in FIG. 1, in this embodiment, the concave lock catches 11 are substituted by two protrusions 511, the lock plugs 23 are removed, the locking portions 522 are two ring-shaped protruding stoppers each with a flat opening and the password portions 521 respectively correspond to the flat openings. FIG. 11 is a cross-sectional view of the zipper password in a locked mode. FIG. 12 is a cross-sectional view of the zipper password lock in an unlocked mode when the lock tongue is not yet withdrawn. As illustrated by FIGS. 10-12, when either one of the dial wheels is rotated to a location where the locking portions 522 is engaged with the protrusion 511 so that the lock tongue cannot be withdrawn from the lock groove, the zipper password lock is in a locked mode; when both of the dial wheels are rotated to locations where the password portions 521 are aligned with the protrusion 511 so that the lock tongue can be withdrawn from the lock groove, the zipper password lock is in an unlocked mode.

While the present patent application has been shown and described with particular references to a number of embodiments thereof, it should be noted that various other changes or modifications may be made without departing from the scope of the present invention.

What is claimed is:

1. A zipper password lock for locking a zipper, comprising:
a lock tongue, the lock tongue comprising a first engaging member disposed at a side of the lock tongue; and
a lock body assembly, the lock body assembly comprising:
a housing having a lock groove for the lock tongue to be inserted into and a mounting base for securing the housing; and
a dial wheel connected to a side of the housing, the dial wheel comprising a first side with a plurality of marks visible to a user, and a second side comprising a password portion corresponding to one of the marks and a plurality of locking portions respectively corresponding to the other marks; wherein:
when the lock tongue is inserted into the lock groove, the dial wheel is configured to be rotated by the user to a first position where one of the locking portions is engaged with the first engaging member so that the zipper password lock is set to a locked mode, and to a second position where the password portion is aligned with the first engaging member and none of the locking portions is engaged with the first engaging member so that the zipper password lock is set to an unlocked mode.

2. The zipper password lock of claim 1, wherein the lock tongue further comprises a third engaging member disposed at another side thereof, and the lock body assembly further comprises another dial wheel connected to another side of the housing, the dial wheel comprising a first side with a plurality of marks visible to a user, and a second side comprising a password portion corresponding to one of the marks and a plurality of locking portions respectively corresponding to the other marks.

3. The zipper password lock of claim 1 further comprising a second engaging member disposed in the housing and axially movable between the dial wheel and the lock tongue, wherein the first engaging member is a concave lock catch, the second engaging member is a protruding lock plug, and when the dial wheel is rotated to the first location, one of the locking portions is indirectly engaged with the first engaging member by pushing the second engaging member to be directly engaged with the first engaging member.

4. The zipper password lock of claim 3, wherein a through hole is configured on a location on the mounting base that corresponds to the location of the second engaging member, the second engaging member comprises a main unit and an extension coaxially fixed to the main unit, the diameter of the main unit is greater than the diameter of the through hole, and the diameter of the extension is less than the diameter of the through hole.

5. The zipper password lock of claim 4, wherein the end of the extension opposing the main unit has a curved shape or a chamber end shape.

6. The zipper password lock of claim 4 further comprising a spring covering the extension, with one end pushing the main unit and the other end pushing the mounting base.

7. The zipper password lock of claim 1, wherein at least one of the upper side and the lower side of the lock tongue comprises a concave portion, a spring clip is disposed on the mounting base of the housing, and at least an end of the spring clip is configured to engage with the concave portion when the lock tongue is inserted into the lock groove.

8. The zipper password lock of claim 7, wherein the spring clip is a C-shaped spring clip with two clipping portions disposed at the two ends thereof, a hollow space corresponding to the shape of the C-shaped spring clip is axially defined in an end of the mounting base facing away from the lock groove, the lock groove is connected through with the hollow space, and the C-shaped spring clip is engaged in the hollow space while the clipping portion is accommodated by the lock groove.

9. The zipper password lock of claim 2, wherein at least a spring positioning member is disposed in the housing between the two dial wheels, one end of the spring positioning member being disposed at a location between the two locking portions on each dial wheel slightly towards the outer edge of the dial wheel.

10. The zipper password lock of claim 9, wherein the spring positioning member comprises a spring and two positioning plugs, the two positioning plugs being respectively disposed at the two ends of the spring and respectively contacting and pushing the two dial wheels.

11. A zipper password lock for locking a two-way zipper, the zipper comprising a first slider and a second slider, the zipper password lock comprising:
a lock tongue fixed to the first slider, the lock tongue comprising a first engaging member disposed at a side of the lock tongue; and
a lock body assembly fixed to the second slider, the lock body assembly comprising:
a housing having a lock groove for the lock tongue to be inserted into and a mounting base for securing the housing; and
a dial wheel connected to a side of the housing, the dial wheel comprising a first side with a plurality of marks visible to a user, and a second side comprising a password portion corresponding to one of the marks and a plurality of locking portions respectively corresponding to the other marks; wherein:
when the lock tongue is inserted into the lock groove, the dial wheel is configured to be rotated by the user to a first position where one of the locking portions is engaged with the first engaging member so that the zipper password lock is set to a locked mode, and to a second position where the password portion is aligned with the first engaging member and none of the locking portions is engaged with the first engaging member so that the zipper password lock is set to an unlocked mode.

12. The zipper password lock of claim 11 further comprising a second engaging member disposed in the housing and axially movable between the dial wheel and the lock tongue, wherein the first engaging member is a concave lock catch, the second engaging member is a protruding lock plug, and when the dial wheel is rotated to the first location, one of the locking portions is indirectly engaged with the first engaging member by pushing the second engaging member to be directly engaged with the first engaging member.

13. The zipper password lock of claim 12, wherein a through hole is configured on a location on the mounting base that corresponds to the location of the second engaging member, the second engaging member comprises a main unit and an extension coaxially fixed to the main unit, the diameter of the main unit is greater than the diameter of the through hole, and the diameter of the extension is less than the diameter of the through hole.

14. The zipper password lock of claim 11, wherein at least one of the upper side and the lower side of the lock tongue comprises a concave portion, a spring clip is disposed on the mounting base of the housing, and at least an end of the spring clip is configured to engage with the concave portion when the lock tongue is inserted into the lock groove.

15. The zipper password lock of claim 11, wherein the lock tongue further comprises a third engaging member disposed at another side thereof, and the lock body assembly further comprises another dial wheel connected to another side of the housing, the dial wheel comprising a first side with a plurality of marks visible to a user, and a second side comprising a password portion corresponding to one of the marks and a plurality of locking portions respectively corresponding to the other marks.

16. A zipper password lock for locking a one-way zipper, the zipper comprising a slider and a fixed member, the zipper password lock comprising:
a lock tongue fixed to one of the slider and the fixed member, the lock tongue comprising a first engaging member disposed at a side of the lock tongue; and
a lock body assembly fixed to the other of the slider and the fixed member, the lock body assembly comprising:
a housing having a lock groove for the lock tongue to be inserted into and a mounting base for securing the housing; and
a dial wheel connected to a side of the housing, the dial wheel comprising a first side with a plurality of marks visible to a user, and a second side comprising a password portion corresponding to one of the marks and a plurality of locking portions respectively corresponding to the other marks; wherein:
when the lock tongue is inserted into the lock groove, the dial wheel is configured to be rotated by the user to a first position where one of the locking portions is engaged with the first engaging member so that the zipper password lock is set to a locked mode, and to a second position where the password portion is aligned with the first engaging member and none of the locking portions is engaged with the first engaging member so that the zipper password lock is set to an unlocked mode.

17. The zipper password lock of claim 16 further comprising a second engaging member disposed in the housing and axially movable between the dial wheel and the lock tongue, wherein the first engaging member is a concave lock catch, the second engaging member is a protruding lock plug, and when the dial wheel is rotated to the first location, one of the locking portions is indirectly engaged with the first engaging member by pushing the second engaging member to be directly engaged with the first engaging member.

18. The zipper password lock of claim 17, wherein a through hole is configured on a location on the mounting base that corresponds to the location of the second engaging member, the second engaging member comprises a main unit and an extension coaxially fixed to the main unit, the diameter of the main unit is greater than the diameter of the through hole, and the diameter of the extension is less than the diameter of the through hole.

19. The zipper password lock of claim 16, wherein at least one of the upper side and the lower side of the lock tongue comprises a concave portion, a spring clip is disposed on the mounting base of the housing, and at least an end of the spring clip is configured to engage with the concave portion when the lock tongue is inserted into the lock groove.

20. The zipper password lock of claim 16, wherein the lock tongue further comprises a third engaging member disposed at another side thereof, and the lock body assembly further comprises another dial wheel connected to another side of the housing, the dial wheel comprising a first side with a plurality of marks visible to a user, and a second side comprising a password portion corresponding to one of the marks and a plurality of locking portions respectively corresponding to the other marks.
